(19) United States
(12) Patent Application Publication
(10) Pub. No.: US 2025/0308065 A1
(43) Pub. Date: Oct. 2, 2025

(54) APPARATUS AND METHOD FOR DETECTING ERRONEOUS MOUNTING OF SLIDE TRAY

(71) Applicant: Curiosis Inc., Seoul (KR)

(72) Inventors: Minseop PARK, Seoul (KR); Dongyoub BAIK, Seoul (KR); Haeryong JEONG, Seoul (KR); Seahun OH, Seoul (KR)

(73) Assignee: Curiosis Inc., Seoul (KR)

(21) Appl. No.: 19/240,051

(22) Filed: Jun. 17, 2025

Related U.S. Application Data
(63) Continuation of application No. PCT/KR2024/015125, filed on Oct. 4, 2024.

(30) Foreign Application Priority Data
Oct. 4, 2023 (KR) 10-2023-0131789
Dec. 8, 2023 (KR) 10-2023-0177443

(51) Int. Cl. G06T 7/73; G02B 21/26; G06T 7/00; G06T 7/13

(52) U.S. Cl. CPC G06T 7/74; G02B 21/26; G06T 7/0002; G06T 7/13; G06T 2207/10056; G06T 2207/30204

(57) ABSTRACT

An example embodiment of the present disclosure provides a method for operating a slide-tray abnormal-mounting detection apparatus, which includes: obtaining a scan image of a first tray; identifying a first marker positioned on the first tray based on the scan image of the first tray; determining whether or not the first marker is positioned within a predetermined normal position range; and outputting an abnormal-mounting detection signal using an output device when the first marker is determined to not be positioned within the predetermined normal position range.

### CROSS-REFERENCE TO RELATED APPLICATIONS

This application is a continuation of International Application No. PCT/KR2024/015125 filed on Oct. 4, 2024, which claims priority to Korean Patent Application No. 10-2023-0131789 filed on Oct. 4, 2023, and Korean Patent Application No. 10-2023-0177443 filed on Dec. 8, 2023, the entire contents of which are herein incorporated by reference.

### TECHNICAL FIELD

The present disclosure relates to a slide-tray abnormal-mounting detection apparatus and method, and more particularly, to an apparatus and method capable of identifying whether or not a slide tray has been normally mounted using a mark presenting in the slide tray and providing, to a user, information indicating whether or not the slide tray has been normally mounted.

### BACKGROUND

The pathology serves to observe, analyze, and diagnose a morphological change in cells, tissues, tissue fluids, and the like of a patient, and provide its results as a treatment guidance to a clinician. In general, in existing cytotechnology or biopsy in the pathology, a medical specialist reads and diagnoses a cell slide or tissue slide of the patient using a microscope with his/her eyes. However, in recent years, a digital slide has been introduced for a pathological diagnosis. In addition to the pathological diagnosis using the microscope, a pathological diagnosis using a digital image obtained by scanning cell staining slides or tissue staining slides has been performed.

A slide with a specimen of the patient may be accommodated in a slide tray. The slide tray may be transported toward a camera by a fork. The slide tray may be scanned by a digital slide scanner. By such a scanning, information about each slide accommodated in the slide tray may be obtained, and the pathological diagnosis may be performed based on such information.

Meanwhile, when the slide tray is transported by the fork or the like, or when the slide tray is inserted into the slide scanner, the slide tray may be abnormally mounted. In such a case, the slide may not be scanned appropriately. Therefore, a method for detecting abnormal-mounting of the slide tray is required.

### SUMMARY OF THE INVENTION

### Problem to be Solved by the Invention

An example embodiment of the present disclosure is for the purpose of an apparatus for detecting abnormal-mounting of a slide tray and a method thereof.

### Means for Solving Problem

An example embodiment of the present disclosure may provide an apparatus for detecting abnormal-mounting of a slide tray and a method thereof.

According to an example embodiment, a method for operating an apparatus that detects abnormal-mounting of a slide tray may include: obtaining a scan image of a first tray; identifying a first marker positioned on the first tray based on the scan image of the first tray; determining whether or not the first marker is positioned within a predetermined normal position range; and outputting an abnormal-mounting detection signal using an output device when the first marker is determined to not be positioned within the predetermined normal position range.

In an aspect, the first marker may be used to indicate a reference direction in which the slide tray is inserted into a slide scanner.

In an aspect, the identifying the first marker positioned on the first tray may include obtaining coordinates of three or more edges of the first marker, and the determining whether or not the first marker is positioned within the predetermined normal position range may include determining whether or not a region determined based on the coordinates of the three or more edges falls within the predetermined normal position range.

In an aspect, the method may further include: before the obtaining of the scan image of the first tray, determining a normal position range. The determining of the normal position range may include: obtaining a normal image of each of a plurality of slide trays which has been normally mounted; identifying one or more markers positioned on each of the plurality of slide trays based on the normal image of each of the plurality of slide trays; determining the normal position range relating to the one or more markers based on the one or more markers; and storing the determined normal position range.

In an aspect, the determining of the normal position range may include: obtaining coordinates of three or more edges of the one or more markers of each of the plurality of normal images; and determining, as the normal position range, a region including the coordinates of the three or more edges of each of the plurality of normal images.

In an aspect, the determining of the normal position range may include: obtaining, for each of the plurality of normal images, a first coordinate of a first edge of the one or more markers and a second coordinate of a second edge of the one or more markers; determining, for each of the plurality of normal images, a vector from the first coordinate to the second coordinate; comparing, for each of the plurality of slide trays, a vector from the first coordinate to the second coordinate with a reference vector to determine a degree of rotation of each of the plurality of slide trays; and determining, based on the degree of rotation for each of the plurality of slide trays, the normal position range.

In an aspect, the determining of the degree of rotation of each of the plurality of slide trays may include: determining at least one of a rotation direction or a rotation angle based on at least one of an x-axis coordinate or a y-axis coordinate of a vector from the first coordinate to the second coordinate.

In an aspect, the method may further include: identifying, based on the scan image of the first tray, a position of a second marker positioned on the first tray; determining whether or not the second marker is positioned within the predetermined normal position range; and identifying, based on the second marker, whether or not the first tray has been normally mounted.

In an aspect, the output device may include at least one of a speaker or a display.

According to another example embodiment of the present disclosure, a slide-tray abnormal-mounting detection apparatus may include: a memory storing information about a normal position range determined based on one or more markers positioned on a slide tray which has been normally mounted; and at least one processor configured to execute one or more instructions stored in the memory. In an example embodiment, the at least one processor may be configured to: obtain a scan image of a first tray; identify, based on the scan image of the first tray, a first marker positioned on the first tray; determine whether or not the first marker is positioned within the normal position range; and output an abnormal-mounting detection signal using an output device when the first marker is determined to not be positioned within the predetermined normal position range.

In an aspect, the first marker may be used to indicate a reference direction for inserting the slide tray into a slide scanner.

In an aspect, the at least one processor may be configured to: obtain coordinates of three or more edges of the first marker; and determine whether or not a region determined based on the coordinates of the three or more edges falls within the predetermined normal position range.

In an aspect, the at least one processor may be configured to: obtain a normal image of each of a plurality of slide trays which has been normally mounted; identify, based on the normal image of each of the plurality of slide trays, one or more markers positioned on each of the plurality of slide trays; and determine, based on the one or more markers, a normal position range relating to the one or more markers; and store the determined normal position range in the memory.

In an aspect, the at least one processor may be configured to: obtain, for each of the plurality of normal images, coordinates of three or more edges of the one or more markers, and determine, as the normal position range, a region including the coordinates of the three or more edges of all of the plurality of normal images.

In an aspect, the at least one processor may be configured to: obtain, for each of the plurality of normal images, a first coordinate of a first edge of the one or more markers and a second coordinate of a second edge of the one or more markers; determine, for each of the plurality of normal images, a vector from the first coordinate to the second coordinate; compare, for each of the plurality of slide trays, a vector from the first coordinate to the second coordinate with a reference vector to determine a degree of rotation of each of the plurality of slide trays; and determine, based on the degree of rotation for each of the plurality of slide trays, the normal position range.

In an aspect, the at least one processor may be configured to determine at least one of a rotation direction or a rotation angle based on at least one of an x-axis coordinate or a y-axis coordinate of a vector from the first coordinate to the second coordinate.

In an aspect, the at least one processor may be configured to: identify, based on a pre-scan image of the first tray, a position of a second marker positioned on the first tray; determine, based on the second marker, whether or not the first tray has been normally mounted.

In an aspect, the output device may include at least one of a speaker or a display.

According to another example embodiment of the present disclosure, there is provided a program stored in a recording medium to cause a computer to execute the aforementioned method according to an example embodiment of the present disclosure.

According to an example embodiment of the present disclosure, there is provided a non-transitory computer-readable recording medium recording a program for causing a computer to execute the aforementioned method according to an example embodiment of the present disclosure.

According to an example embodiment of the present disclosure, there is provided a computer-readable recording medium recording a database used in an example embodiment of the present disclosure.

### Effect of the Invention

According to example embodiments of the present disclosure, it is possible to detect whether or not a slide tray has been abnormally mounted using one or more markers presenting in a slide tray, and issuing an alarm to a user when the slide tray is determined to be abnormally mounted.

### BRIEF DESCRIPTION OF THE DRAWINGS

FIG. 1 is a diagram illustrating a slide tray according to an example embodiment of the present disclosure.

FIG. 2 is a diagram illustrating the slide tray in which a slide according to an example embodiment of the present disclosure is accommodated.

FIG. 3 is a diagram illustrating a method for determining a normal position range according to an example embodiment of the present disclosure.

FIG. 4 is a diagram illustrating a method for identifying whether or not the slide tray has been normally mounted according to an example embodiment of the present disclosure.

FIG. 5 is a block diagram of a slide-tray abnormal-mounting detection apparatus according to an example embodiment of the present disclosure.

### DETAILED DESCRIPTION

Example embodiments of the present disclosure will be described in detail with reference to the accompanying drawings for the clarification of the technical sprit of the present disclosure. Here, in the description of the present disclosure, when it is determined that a detailed description of a related known function or configuration may unnecessarily obscure the gist of the present disclosure, the detailed description thereof will be omitted. In the drawings, constituent elements that are substantially the same in configuration will be denoted by the same reference numeral and symbols as possible even if they are displayed on the other drawings. For the sake of convenience in description, both an apparatus and a method will be described if necessary. Operations described in the present disclosure may not be necessarily performed in a sequence described herein but may be performed in a parallel manner, a selective manner or an individual manner.

Terms used in example embodiments of the present disclosure are general terms that are currently widely used while their respective functions in the present disclosure are taken into consideration. However, the terms may be changed depending on the intention of one of ordinary skilled in the art, legal precedents, emergence of new technologies, and the like. Also, in particular cases, terms that are arbitrarily selected by the applicant of the present disclosure may be used, and in this case, the meanings of these terms may be described in detail in the corresponding disclosure. Accordingly, the terms used herein should be defined based on the meanings thereof and the content throughout the specification, instead of a simple name of the term.

In the present disclosure, expressions in the singular form should be understood to encompass expressions in the plural form unless the context clearly indicates otherwise. The term “comprises”, “includes”, “has” or the like are intended to include features, numeric characters, operations, acts, constituent elements, parts, or a combination thereof, and should be understood not to exclude one or more other features, numeric characters, operations, acts, constituent elements, parts, or a combination thereof, or additional features and the like. When a part “comprise or includes” a constituent element through the specification, this means that the part may further include other constituent elements, rather than excluding other constituent elements, unless other stated.

The expression such as “at least one” encompass the entire list of components and does not individually represent respective constituent elements in the list. For example, the expression “at least one of A, B, and C” may include the following meanings: “A alone”, “B alone”, “C alone”, “both A and B together”, “both A and C together”, “both Band C together”, or “all three of A, B, and C together”.

In addition, the terms such as “part,” “- - - er, - - - or,” “module” and the like used herein may refer to a unit that performs at least one function or operation, which may be realized as hardware or software, or may be realized as a combination of hardware and software.

In the present disclosure, when one constituent element is referred to as being “connected” to another constituent element, the one constituent element may be “directly connected” to another constituent element, or may be “indirectly connected” or “electrically connected” to another constituent element by intervening yet another constituent element therebetween. When a part “comprise or includes” a constituent element through the specification, this means that the part may further include other constituent elements, rather than excluding other constituent elements, unless other stated.

The expression “configured (or set) to - - - ” described herein may be alternatively expressed to, for example, “suitable for - - - ,” “having the capacity to - - - ,” “designed to - - - ,” “adapted to - - - ,” “made to - - - ,” “capable of - - - ,” or the like depending on situations. The expression “configured (or set) to - - - ” may not necessarily mean only “specifically designed to - - -” in hardware. Alternatively, in some circumstances, the expression “system configured to - - - ” may mean that the system is “capable of - - - ” together with other apparatus(es) or constituent element(s). The phrase “processor configured (or set) to perform A, Band C” may mean, for example, a dedicated processor (for example, embedded process) configured to perform a respective operation, or a generic-purpose processor (for example, a central processing unit (CPU) or an application processor) capable of performing respective operations by executing one or more software programs stored in a memory.

Further, although the terms including ordinal numbers such as a first, a second and the like used herein may be used to describe various constituent elements, such constituent elements should not be limited by terms including the ordinal numbers. The above terms may be used to distinguish a constituent element from another constituent element in a description of the specification in context. For example, a first constituent element may be named as a second constituent element in another description of the specification without departing from the scope of the present disclosure. Conversely, the second constituent element may be named as the first constituent element in another description of the specification. The term “and/or” may be used to represent a combination of a plurality of related items described herein or at least one of the plurality of related items.

In the present disclosure, a thin flat piece of glass used when fixing a specimen may include a slide glass, a glass slide, a specimen slide, a microscope slide, a slide on which the specimen is placed on the slide glass and then the specimen is covered with a cover glass, or the like. However, the present disclosure is not limited thereto.

In the present disclosure, the slide tray may be a case for conveying or storing slides and may be referred to as a tray, a glass plate, a slide plate, a slide holder, a glass holder, a slide case, a glass case, a slide folder, a glass folder, or the like.

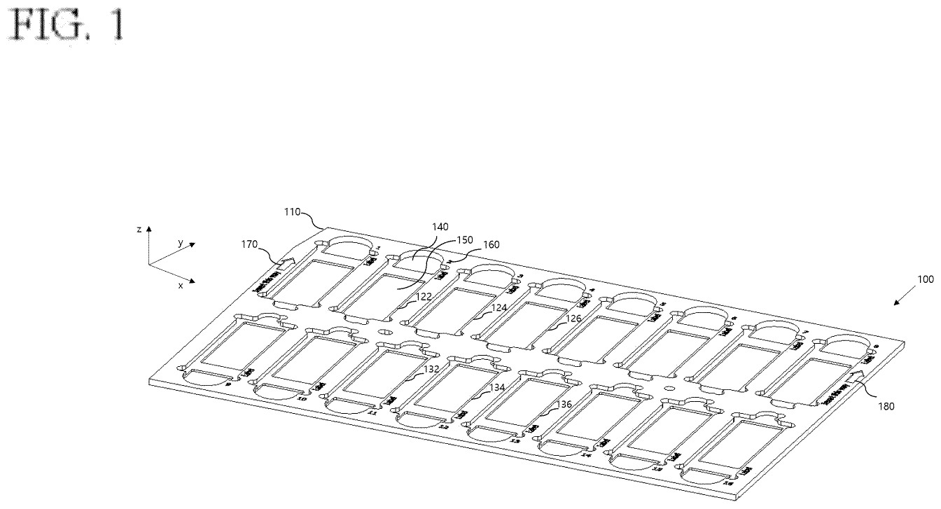

FIG. 1 is a diagram illustrating a slide tray according to an example embodiment of the present disclosure.

Referring to FIG. 1, a slide tray 100 may include a planar member 110. Further, a plurality of slide accommodation portions, which is constituted with grooves capable of accommodating a slide, may be formed in one surface of the planar member 110. For example, the plurality of slide accommodation portions may include a first slide accommodation portion 122, a second slide accommodation portion 124, a third slide accommodation portion 126, a fourth slide accommodation portion 132, a fifth slide accommodation portion 134, a sixth slide accommodation portion 136, and the like. In an example embodiment, the plurality of slide accommodation portions may be formed in a structure in which grooves having a thickness equal to or greater than that of the slide are formed from the planar member 110.

In an example embodiment, the plurality of slide accommodation portions may be formed at an interval on the planar member 110. For example, the slide tray 100 illustrated in FIG. 1 will be described by way of example. The planar member 110 of the slide tray 100 has a rectangular shape. Eight slide accommodation portions including the first slide accommodation portion 122, the second slide accommodation portion 124, and the third slide accommodation portion 126 may be formed at a predetermined interval in a first row of the planar member 110. Eight slide accommodation portions including the fourth slide accommodation portion 132, the fifth slide accommodation portion 134, and the sixth slide accommodation portion 136 may be formed at a predetermined interval in a second row different from the first row. Further, the slide accommodation portions formed in the first row and the slide accommodation portions formed in the second row may be formed with a predetermined gap left from each other. However, this configuration is merely one example. The number of slide accommodation portions included in the slide tray 100, the shape of the planar member 110, the configuration in which the plurality of slide accommodation port are formed at the predetermined interval, and the like are not limited to the foregoing but may be varied in other various manners.

In an example embodiment, at least a part of each of the plurality of slide accommodation portions may be formed with a hollow portion. For example, a first hollow portion 140 and a second hollow portion 150 may be formed in the first slide accommodation portion 122. Alternatively, only the first hollow portion 140 may be formed in the first slide accommodation portion 122. However, this configuration is merely one example. Each of the plurality of slide accommodation portions may include at least one of a hollow portion corresponding to the first hollow portion 140 or a hollow portion corresponding to the second hollow portion 150, and may further include hollow portions other than the first hollow portion 140 and the second hollow portion 150. According to an example embodiment, the first hollow portion 140 is to lift up the slide accommodated in the slide accommodation portion therefrom. A user who uses the slide tray 100 may smoothly lift up the slide placed on the slide tray 100 using the first hollow portion 140. Thus, the first hollow portion 140 may correspond to a hole that is easy to grip the slide by fingers of the user. In an example embodiment, the first hollow portion 140 may have an outer curved surface. For example, the first hollow portion 140 may have a shape composed of a circle, a semicircle, a portion of a circumference, a straight line, and the like.

In an example embodiment, an adsorptive film (not illustrated) may be attached to at least a part of each of the plurality of slide accommodation portions such that the slide may be detachably attached to the slide accommodation portion. When the slide is accommodated in the slide accommodation portion, the adsorptive film may serve to secure a relative position between the slide and the slide accommodation portion. When the slide is accommodated in the slide accommodation portion, a coupling force between the slide and the slide accommodation portion may be generated by the adsorptive film. For example, the coupling force between the slide and the slide accommodation portion may include an electrostatic force as an intermolecular coupling force.

In an example embodiment, the adsorptive film may include a film using an electrostatic force, a porous adsorptive film, a film using Van der Waals force, a film using a covalent coupling force, an adhesive film, or the like. For example, when the porous adsorptive film is used, the slide may be accommodated in the slide accommodation portion in a vacuum adsorption manner using a porous material between the slide and the slide accommodation portion. Further, an example of the adhesive film may include an adhesive tape.

According to an example embodiment, the adsorptive film is used to increase a fixing force between the slide tray and the slide, which may eliminate a need to supply energy other than an appropriate external force when lifting up the slide. Accordingly, other equipment such as a spring, an electric wire, an air pipe, and the like do not need to be provided, which achieves a reduction in manufacturing cost of the slide tray.

In an example embodiment, the adsorptive film may include a base made of a polymer-based material and a coating layer made of a resin material. According to an example embodiment, the coating layer made of the resin material may be used to repeatedly use the slide tray. Further, in a case in which the adsorption force of the adsorptive film is degraded due to such a repetitive use, the adsorptive film may be replaced with a new one.

In an example embodiment, the first hollow portion 140 may be a hollow portion for lifting up the slide accommodated in the first slide accommodation portion 122 from the first slide accommodation portion 122. When the slide is accommodated in one surface of the first slide accommodation portion 122, some areas of the first hollow portion 140 are covered by the slide in a direction orthogonal to one surface of the planar member 110, and other areas thereof may be exposed in a direction orthogonal to the one surface of the planar member 110. Further, when the slide is accommodated in one surface of the first slide accommodation portion 122, the entire area of the second hollow portion 150 may be covered by the slide.

In an example embodiment, various markers may be positioned on the planar member 110. For example, the markers may include a marker indicating identification information about the slide tray 100, markers 170 and 180 indicating information about a reference direction for inserting the slide tray into a slide scanner, a marker 160 indicating identification information about the slide accommodation portion, and the like. For example, the marker indicating the identification information about the slide tray 100 may be configured to indicate a serial number of the slide tray 100, and the marker indicating the identification information about the slide accommodation portion may be configured to indicate an identification number indicating an order of the slide accommodation portion. In an example embodiment, the slide scanner may be an equipment for scanning the slide accommodated in the first slide accommodation portion to obtain a high-resolution digital image. The slide scanner may be referred to as a digital slide scanner. The slide scanner may automatically scan a plurality of slides to generate a digital slide image.

According to an example embodiment, the marker indicating the identification information about the slide tray, the markers 170 and 180 indicating the information about the reference direction for inserting the slide tray into the slide scanner, and the like are provided on the slide tray 100. Thus, pieces of information for easily analyzing the slides stored in the slide tray may be provided.

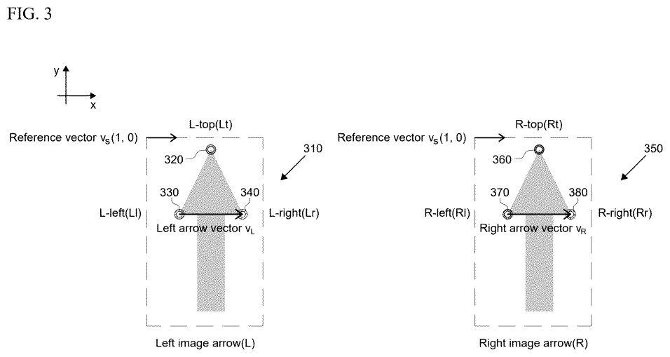

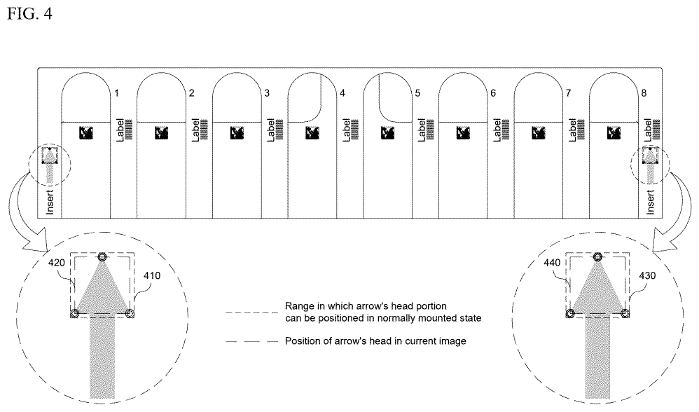

Further, the markers positioned on the slide tray may serve as a measure for identifying whether or not the slide tray is properly positioned in the slide scanner or on a fork or the like. This will be described in more detail below with reference to FIGS. 3 and 4.

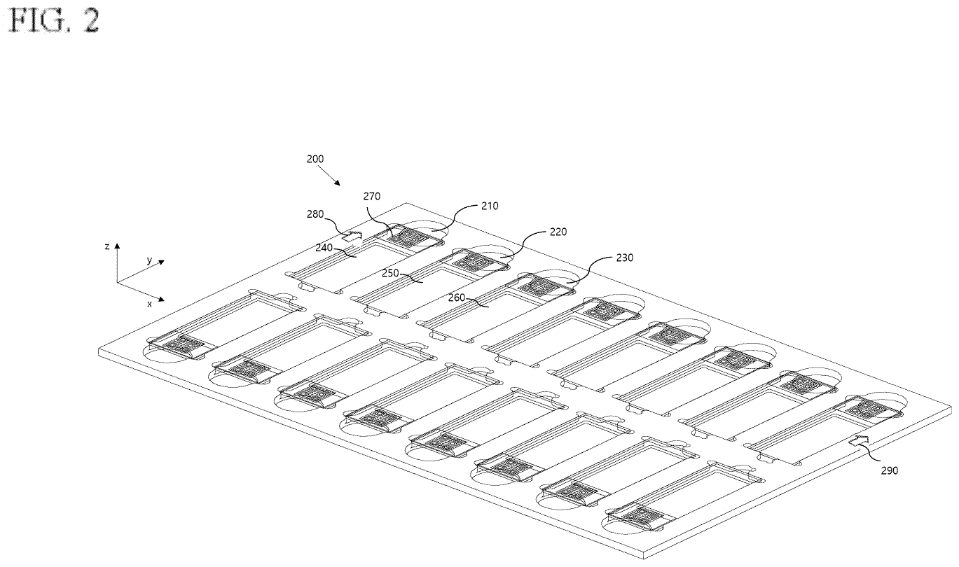

FIG. 2 is a diagram illustrating a slide tray on which a slide is accommodated according to an example embodiment of the present disclosure.

Referring to FIG. 2, there is illustrated a slide tray 200 in which slides 240, 250 and 260 are accommodated in the plurality of slide accommodation portions. In an example embodiment, the slide tray 200 may correspond to the slide tray 100 described above with reference to FIG. 1. In an example embodiment, the slide 240, 250 and 260 may be accommodated in the respective slide accommodation portions. In order to properly accommodate the slides 240, 250 and 260, a horizontal length (length in an x-axis) and a groove height (length in a z-axis) of each slide accommodation portion may correspond to a horizontal length (length in the z-axis) and a thickness (length in the z-axis) of the slide. However, at least a portion of a length of the groove corresponding to the slide accommodation portion in the y-axis may be formed to be longer than a longitudinal length of the slide (length in the y-axis). Thus, the user who uses the slide tray 200 may easily lift up the slides 240, 250 and 260 from the respective slide accommodation portions using gaps between the slides 240,250 and 260 and the respective slide accommodation portions. For example, the user may place a portion of his/her finger in the gaps between the slides 240, 250 and 260 and the respective slide accommodation portions and lifts up the slides 240, 250 and 260.

In an example embodiment, the slide 240 may include specimen information 270 obtained by using at least one of a numeric character, a letter, a quick response (QR) code, or a barcode. Further, the specimen information may correspond to at least one of the name, gender, age and case history of a subject, or the specimen information.

In an example embodiment, the specimen information 270 may be used when the slide tray 200 is transferred into the slide scanner and is scanned by the slide scanner. For example, the slide scanner may scan the specimen information 270 included in the slide 240 while scanning the specimen included in the slide 240 to identify which subject the specimen corresponds to, may map the scanned specimen and the scanned specimen information 270 to each other and store such mapped information. Further, in the case in which the specimen information 270 includes the case of the subject, the slide scanner may map the specimen information 270 including the case history of the subject to the scanned specimen. This makes it possible for an operator to more accurately perform pathological diagnosis.

In an example embodiment, the slide tray 200 may include one or more markers. For example, the slide tray 200 may include a first marker 280 and a second marker 290 which are used to indicate the reference direction in which the slide tray 200 is inserted into the slide scanner. As illustrated in FIG. 2, the first marker 280 and the second marker 290 may be formed in arrow shapes, or may be formed in a triangle shape. However, the shapes of the first marker 280 and the second marker 290 are not limited thereto, and may be formed in various shapes for indicating the reference direction.

In an example embodiment, the first marker 280 and the second marker 290 may serve as a guide to indicate the insertion direction of the slide tray to the slide scanner as well as serve as a marker to identify whether or not the slide tray 200 has been normally mounted. Details thereof will be described with reference to FIGS. 3 and 4. Although in FIGS. 3 and 4, the first marker 280 and the second marker 290 are illustrated as examples, example embodiments illustrated in FIGS. 3 and 4 may also be applied to other markers on the slide tray 200, other than the first marker 280 and the second marker 290.

FIG. 3 is a diagram illustrating a method for determining a normal position range according to an example embodiment of the present disclosure.

Referring to FIG. 3, a slide-tray abnormal-mounting detection apparatus may determine a normal position range based on one or more markers 310 and 350 positioned on the slide tray which has been normally mounted. In an example embodiment, the slide-tray abnormal-mounting detection apparatus may obtain a plurality of normal images of the slide tray which has been normally mounted. In an example embodiment, the normal image is a reference image for determining whether or not the slide tray has been abnormally mounted and may be an image selected in advance, which represents that the slide tray has been normally mounted. For example, the slide-tray abnormal-mounting detection apparatus may determine the normal position range using 20 normal images in which the slide tray has been normally mounted.

In an example embodiment, the slide-tray abnormal-mounting detection apparatus may identify the one or more markers 310 and 350 positioned on the slide tray, which correspond to each of the plurality of obtained normal images, and obtain coordinates of one or more edges of the one or more markers 310 and 350 thus identified. Further, the slide-tray abnormal-mounting detection apparatus may determine the normal position range of the one or more markers 310 and 350 based on the coordinates of the one or more edges.

In an example embodiment, the slide-tray abnormal-mounting detection apparatus may obtain edge coordinates of a plurality of normal images and determine the normal position range so that all of the coordinates of the one or more edges fall within the normal position range. For example, the normal position range may be defined as a square range, a triangular range, a circular range, a range of a shape corresponding to each marker, and the like.

In an example embodiment, a case in which the slide-tray abnormal-mounting detection apparatus identifies the first marker 310 as a left arrow marker and the second marker 350 as a right arrow marker from a digital image of the slide tray will be described in more detail by way of example. The slide-tray abnormal-mounting detection apparatus may obtain the coordinates of the one or more edges of the first marker 310 and the second marker 350. For example, for the first marker 310, a coordinate of a first edge 320, a coordinate of a second edge 330, and a coordinate of a third edge 340 may be obtained. For the second marker 350, a coordinate of a fourth edge 360, a coordinate of a fifth edge 370, and a coordinate of a sixth edge 380 may be obtained.

In an example embodiment, the slide-tray abnormal-mounting detection apparatus may determine the normal position range based on the one or more coordinates obtained as above.

In an example embodiment, the slide-tray abnormal-mounting detection apparatus may determine the normal position range relating to the slide tray with reference to a case in which the coordinates of the one or more edges, which are obtained from the normal image, fall within the normal position range. For example, the slide-tray abnormal-mounting detection apparatus may determine the normal position range for the first marker 310 as a region including the coordinates of the edges obtained from the normal images, that is, the coordinate of the first edge 320, the coordinate of the second edge 330, and the coordinate of the third edge 340. Similarly, the slide-tray abnormal-mounting detection apparatus may determine the normal position range for the second marker 350 as a region including the coordinates of the edges obtained from the normal images, that is, the coordinate of the fourth edge 360, the coordinate of the fifth edge 370, and the coordinate of the sixth edge 380. Further, the slide-tray abnormal-mounting detection apparatus may identify coordinates of edges of other normal images other than the normal images, and determine the normal position range such that the coordinates of the edges of all of the normal images fall within the normal position range.

In another example embodiment, a vector from the second edge 330 to the third edge 340 may be determined based on the coordinate of the second edge 330 and the coordinate of the third edge 340. The normal position range for the slide tray may be determined based on the vector. For example, in FIG. 3, assuming that a unit vector in the X-axis is defined as a reference vector Vₛ (1, 0), when the coordinate of the second edge 330 is (3, −5) and the coordinate of the third edge 340 is (6, −5.5), a left arrow vector V_{L} from the second edge 330 to the third edge 340 may be determined as (3, −0.5). Thus, the slide-tray abnormal-mounting detection apparatus may identify that the slide tray is rotated by 0.5 degrees clockwise based on a y coordinate (−0.5) of the left arrow vector V_{L}. When the coordinate of the left arrow vector V_{L} is positive, the slide-tray abnormal-mounting detection apparatus may determine that the slide tray is rotated counterclockwise. That is, the slide-tray abnormal-mounting detection apparatus may determine a degree of rotation of the slide tray by comparing the reference vector and the left arrow vector. The degree of rotation may include a rotation direction, a rotation angle, and the like. However, this is merely an example and a method for determining the degree of rotation is not limited thereto. The slide-tray abnormal-mounting detection apparatus may repeatedly perform the above operation on the plurality of normal images to determine degrees of rotation of the plurality of normal images. In addition, the slide-tray abnormal-mounting detection apparatus may determine the normal position range so as to include all the degrees of rotation of the plurality of normal images. Similarly, the vector from the first edge to the second edge, a vector from the third edge to the first edge, and the like may be used. That is, the slide-tray abnormal-mounting detection apparatus may use two or more edge coordinates out of the plurality of edge coordinates to obtain a vector from one edge to another edge and determine the rotation direction and the rotation angle based on such a vector. Accordingly, the normal position range may be determined to include both the rotation direction and the rotation angle of the normal images for respective markers. More preferably, the normal images may be in a state in which they are not rotated at all or are rotated at a minimum.

In an example embodiment, when identifying the degree of rotation of the slide tray and determining the normal position range based on the degree of rotation, the slide-tray abnormal-mounting detection apparatus may use only the first marker, may use both the first marker and the second marker, or may use other markers. For example, the slide-tray abnormal-mounting detection apparatus may identify the degree of rotation of the slide tray based on a right arrow vector V_{R} from the fifth edge 370 to the sixth edge 380 in addition to the left arrow vector V_{L}, and determine the normal position range for the first marker as well as the normal position range for the second marker. Accordingly, even if one marker falls within the normal position range, the slide-tray abnormal-mounting detection apparatus may determine that the slide has been normally mounted. Alternatively, when all of the markers fall within the normal position range, the slide-tray abnormal-mounting detection apparatus may determine that the slide has been normally mounted.

In an example embodiment, the slide-tray abnormal-mounting detection apparatus may repeatedly perform the above operation on the normal images of the plurality of slide trays to identify at least one of the coordinates or the degrees of rotation in the normally mounted state, and determine the normal position range based on the at least one of the coordinates and the degrees of rotation in the normally mounted state. That is, the slide-tray abnormal-mounting detection apparatus may determine the normal position range so as to include all of the coordinates in the normally mounted state, or determine the normal position range so as to include all of the degrees of rotation. For example, the slide-tray abnormal-mounting detection apparatus may determine a first normal position range 410 in FIG. 4 as a normal position range of a left arrow's head portion, and determine a second normal position range 430 in FIG. 4 as a normal position range of a right arrow's head portion such that all coordinates of arrow's head portions of the normal images are included in the first normal position range 410 and the second normal position range 430.

In an example embodiment, the slide-tray abnormal-mounting detection apparatus may store the normal position ranges determined as above in a memory or a database.

FIG. 4 is a diagram illustrating a method for identifying whether or not the slide tray has been normally mounted according to an example embodiment of the present disclosure.

Referring to FIG. 4, the slide-tray abnormal-mounting detection apparatus may obtain a scan image of a first tray and identify one or more markers positioned on the first tray based on the scan image of the first tray. For example, the slide-tray abnormal-mounting detection apparatus may identify a left arrow marker and a right arrow marker which are positioned on the first tray. Based on the one or more markers identified as above, the slide-tray abnormal-mounting detection apparatus may determine whether or not the one or more markers fall within a normal position range. For example, assuming that a region where the left arrow's head portion is positioned is referred to as the first region 420, the slide-tray abnormal-mounting detection apparatus may determine whether or not the first region 420 falls within the first normal position range 410. Further, assuming that a region where the right arrow's head portion is positioned is referred to as the second region 440, the slide-tray abnormal-mounting detection apparatus may determine whether or not the second region 440 falls within the normal position range 430.

In one example, the slide-tray abnormal-mounting detection apparatus may obtain coordinates of three edges of the left arrow's head portion and identify whether or not all of the coordinates of the three edges fall within the first normal position range 410. Further, the slide-tray abnormal-mounting detection apparatus may obtain coordinates of three edges of the right arrow's head portion and identify whether or not all of the coordinates of the three edges fall within the second normal position range 430.

In another example, based on the edge coordinates of the left arrow's head portion, the slide-tray abnormal-mounting detection apparatus may determine at least one vector which connects two edges, determine a degree of rotation (for example, a rotation direction and a rotation angle) based on the at least one vector, and identify whether or not the degree of rotation falls within the first normal position range 410. Similarly, based on the edge coordinates of the right arrow's head portion, the slide-tray abnormal-mounting detection apparatus may determine at least one vector which connects two edges, determine the degree of rotation (for example, the rotation direction and the rotation angle) based on the at least one vector, and identify whether or not the degree of rotation falls within the second normal position range 430.

In an example embodiment, when one of the first marker and the second marker falls within the normal position range, the slide-tray abnormal-mounting detection apparatus may determine that the slide tray has been normally mounted. Alternatively, when both of the first marker and the second marker fall within the normal position range, the slide-tray abnormal-mounting detection apparatus may determine that the slide tray has been normally mounted. Alternatively, when all of the markers identified as above fall within the normal position range, the slide-tray abnormal-mounting detection apparatus may determine that the slide tray has been normally mounted. Alternatively, when at least one of the markers identified as above satisfies a predetermined reference and fall within the normal position range, the slide-tray abnormal-mounting detection apparatus may determine that the slide tray has been normally mounted.

In an example embodiment, when one of the first marker and the second marker falls outside the normal position range, the slide-tray abnormal-mounting detection apparatus may determine that the slide tray has been abnormally mounted. Alternatively, when both of the first marker and the second marker fall outside the normal position range, the slide-tray abnormal-mounting detection apparatus may determine that the slide tray has been abnormally mounted. Alternatively, when all of the markers identified as above fall outside the normal position range, the slide-tray abnormal-mounting detection apparatus may determine that the slide tray has been abnormally mounted. Alternatively, when at least one of the markers identified as above satisfies the predetermined reference and fall outside the normal position range, the slide-tray abnormal-mounting detection apparatus may determine that the slide tray has been abnormally mounted.

In an example embodiment, when the slide tray is determined to be abnormally mounted, the slide-tray abnormal-mounting detection apparatus may output an abnormal-mounting detection signal using an output device. Examples of the output device may include a display, a speaker, a light emitting element, and the like. In an example embodiment, when the slide tray is determined to be abnormally mounted, the slide-tray abnormal-mounting detection apparatus may further output an abnormal-mounting alarm signal, information about how the slide tray is abnormally mounted, auxiliary information relating to a normal mounting, or the like. For example, the slide-tray abnormal-mounting detection apparatus may output information about a rotation, a movement direction, rotation angle or the like of the first tray. Alternatively, the slide-tray abnormal-mounting detection apparatus may output information about a direction or angle in or at which the first tray is to be rotated or moved for normal mounting.

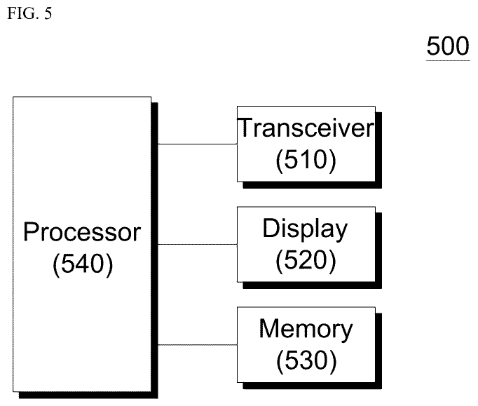

FIG. 5 is a block diagram of the slide-tray abnormal-mounting detection apparatus according to an example embodiment of the present disclosure.

Referring to FIG. 5, a slide-tray abnormal-mounting detection apparatus 500 may include a transceiver 510, an output device 520, a memory 530, and a processor 540. However, all of constituent elements illustrated in FIG. 5 are not essential in the slide-tray abnormal-mounting detection apparatus 500. The slide-tray abnormal-mounting detection apparatus 500 may be implemented with more constituent elements than the constituent elements illustrated in FIG. 5, or with fewer constituent elements than the constituent elements illustrated in FIG. 5. Further, the transceiver 510, the output device 520, the memory 530, and the processor 540 may be implemented in the form of a single chip.

In an example embodiment, the transceiver 510 may communicate with a slide tray slot, a user terminal, or other electronic devices which is (are) connected to the slide-tray abnormal-mounting detection apparatus 500 in a wired or wireless manner.

In an example embodiment, the output device 520 may include a display, a light emitting element, a speaker, and the like. The display may include a panel, a hologram device, a projector, and the like. For example, when the slide-tray abnormal-mounting detection apparatus 500 detects that the slide tray has been abnormally mounted, it may output information indicating that the slide tray has been abnormally mounted to the display, or output a signal indicating that the slide tray has been abnormally mounted via the speaker.

A variety of kinds of data, such as programs such as applications, files, and the like., may be installed and stored in the memory 530. The processor 540 may access and use the data stored in the memory 530, or may store new data in memory 530. In an example embodiment, the memory 530 may include a database. For example, the normal position range relating to one or more markers positioned on the slide tray which has been normally mounted, may be stored in the memory or the database.

The processor 540 controls the overall operation of the slide-tray abnormal-mounting detection apparatus 500, and may include at least one or more processors such as a control processing unit (CPU), a graphics processing unit (GPU), and the like. The processor 540 may control other configurations included in the slide-tray abnormal-mounting detection apparatus 500 to execute the operation of the slide-tray abnormal-mounting detection apparatus 500. For example, the processor 540 may execute the program stored in the memory 530, read the file stored in the memory 530, or store the new file in the memory 530. In an example embodiment, the processor 540 may obtain a scan image of a first tray by executing the program stored in the memory 530, and identify a first marker positioned in the first tray based on the scan image of the first tray, determine whether or not the first marker is positioned within a predetermined normal position range, and when the first marker is determined to not be positioned within the predetermined normal position range, output an abnormal-mounting detection signal using the output device.

In an example embodiment, the first marker may be a marker used to indicate the reference direction for inserting the slide tray into the slide scanner, for example, the marker 310 or 350.

In an example embodiment, the processor 540 may obtain coordinates of three or more edges of the first marker, and determine whether or not a region determined based on the coordinates of the three or more edges falls within the predetermined normal position range.

In an example embodiment, the processor 540 may: obtain a plurality of normal images in which the slide tray has been normally mounted; based on the plurality of normal images, identify one or more markers positioned on the slide tray which corresponds to each of the plurality of normal images; based on the one or more markers, determine the normal position range relating to the one or more markers; and store the normal position range in the memory or the database.

In an example embodiment, the processor 540 may obtain, for each of the plurality of normal images, coordinates of three or more edges of the one or more markers, and determine, as the normal position range, a region including the coordinates of the three or more edges of each of the plurality of normal images. For example, for each of the plurality of normal images illustrated in FIG. 3, the processor 540 may obtain the first coordinate 320, the second coordinate 330, and the third coordinate 340, and determine, as the normal position range relating to the first marker 310, a region including all of the first coordinate 320, the second coordinate 330, and the third coordinate 340 of each of the plurality of normal images.

In an example embodiment, for each of the plurality of normal images, the processor 540 may obtain a first coordinate of a first edge of the one or more markers and a second coordinate of a second edge of the one or more markers, determine, for each of the plurality of normal images, a vector from the first coordinate to the second coordinate, and compare the vector from the first coordinate to the second coordinate with a reference vector for each of the plurality of normal images, to determine a degree of rotation of the slide tray, and determine, based on the degree of rotation for each of the plurality of slide trays, the normal position range.

In an example embodiment, the processor 540 may determine at least one of a rotation direction or a rotation angle based on at least one of an x-axis coordinate or a y-axis coordinate of the vector from the first coordinate to the second coordinate.

In an example embodiment, the processor 540 may identify, based on the scan image of the first tray, a position of the second marker positioned on the first tray, and identify, based on the position of the first marker and the position of the second marker, whether or not the first tray has been normally mounted.

An example embodiment of the present disclosure may be implemented in the form of a recording medium recording computer-executable instructions such as computer-executable program modules. A computer-readable medium may be any available medium to which the computer may access, and may include both a volatile and nonvolatile medium, a removable and a non-removable medium. Further, the computer-readable medium may include both a computer storage medium and a communication medium. The computer storage medium includes both a volatile and nonvolatile medium, and a removable and non-removable medium, which are implemented by any method or technology for storing information, such as computer-readable instructions, data structures, a program modules or other data. In typical, the communication medium may include computer-readable instructions, data structures, or program modules, and may include any information delivery medium.

The above descriptions of the present disclosure are merely examples and the present disclosure may be changed in other specific forms by those skilled in the art without altering the technical ideas or essential features of the present disclosure. Therefore, the example embodiments described above should be understood to be illustrative in all respects and not restrictive. For example, individual constituent elements described in a singular form may be implemented in a distributed fashion. Similarly, the constituent elements described to be distributed may be implemented in a combined form.

Therefore, the spirit of the present disclosure need not to be limited to the above-described example embodiments, and in addition to the appended claims to be described below. and all ranges equivalent to or changed from these claims need to be said to belong to the scope and spirit of the present disclosure.

What is claimed is:

1. A slide tray abnormal-mounting detection method, comprising:
obtaining a scan image of a first tray;
identifying a first marker positioned on the first tray based on the scan image of the first tray;
determining whether or not the first marker is positioned within a predetermined normal position range; and
outputting an abnormal-mounting detection signal using an output device when the first marker is determined to not be positioned within the predetermined normal position range.

2. The slide tray abnormal-mounting detection method of claim 1, wherein the first marker is used to indicate a reference direction in which the slide tray is inserted into a slide scanner.

3. The slide tray abnormal-mounting detection method of claim 1, wherein the identifying the first marker positioned on the first tray includes obtaining coordinates of three or more edges of the first marker, and
wherein the determining whether or not the first marker is positioned within the predetermined normal position range includes determining whether or not a region determined based on the coordinates of the three or more edges falls within the predetermined normal position range.

4. The slide tray abnormal-mounting detection method of claim 1, further comprising:
before the obtaining of the scan image of the first tray, determining a normal position range, wherein the determining of the normal position range includes:
obtaining a normal image of each of a plurality of slide trays which has been normally mounted;
identifying one or more markers positioned on each of the plurality of slide trays based on the normal image of each of the plurality of slide trays;
determining the normal position range relating to the one or more markers based on the one or more markers; and
storing the determined normal position range.

5. The slide tray abnormal-mounting detection method of claim 4, wherein the determining of the normal position range includes:
obtaining coordinates of three or more edges of the one or more markers of each of the plurality of normal images; and
determining, as the normal position range, a region including the coordinates of the three or more edges of each of the plurality of normal images.

6. The slide tray abnormal-mounting detection method of claim 4, wherein the determining of the normal position range includes:
obtaining, for each of the plurality of normal images, a first coordinate of a first edge of the one or more markers and a second coordinate of a second edge of the one or more markers;
determining, for each of the plurality of normal images, a vector from the first coordinate to the second coordinate;
comparing, for each of the plurality of slide trays, a vector from the first coordinate to the second coordinate with a reference vector to determine a degree of rotation of each of the plurality of slide trays; and
determining, based on the degree of rotation for each of the plurality of slide trays, the normal position range.

7. The slide tray abnormal-mounting detection method of claim 6, wherein the determining of the degree of rotation of each of the plurality of slide trays includes:
determining at least one of a rotation direction or a rotation angle based on at least one of an x-axis coordinate or a y-axis coordinate of a vector from the first coordinate to the second coordinate.

8. The slide tray abnormal-mounting detection method of claim 1, further comprising:
identifying, based on the scan image of the first tray, a position of a second marker positioned on the first tray;
determining whether or not the second marker is positioned within the predetermined normal position range; and
identifying, based on the second marker, whether or not the first tray has been normally mounted.

9. The slide tray abnormal-mounting detection method of claim 1, wherein the output device includes at least one of a speaker or a display.

10. A slide-tray abnormal-mounting detection apparatus comprising:
a memory storing information about a normal position range determined based on one or more markers positioned on a slide tray which has been normally mounted; and
at least one processor configured to execute one or more instructions stored in the memory,
wherein the at least one processor is configured to:
obtain a scan image of a first tray;
identify, based on the scan image of the first tray, a first marker positioned on the first tray;
determine whether or not the first marker is positioned within the normal position range; and
output an abnormal-mounting detection signal using an output device when the first marker is determined to not be positioned within the normal position range.

11. The slide-tray abnormal-mounting detection apparatus of claim 10, wherein the first marker is used to indicate a reference direction for inserting the slide tray into a slide scanner.

12. The slide-tray abnormal-mounting detection apparatus of claim 10, wherein the at least one processor is configured to:
obtain coordinates of three or more edges of the first marker; and
determine whether or not a region determined based on the coordinates of the three or more edges falls within the normal position range.

13. The slide-tray abnormal-mounting detection apparatus of claim 10, wherein the at least one processor is configured to:
obtain a normal image of each of a plurality of slide trays which has been normally mounted;
identify, based on the normal image of each of the plurality of slide trays, one or more markers positioned on each of the plurality of slide trays;
determine, based on the one or more markers, a normal position range relating to the one or more markers; and
store the determined normal position range in the memory.

14. The slide-tray abnormal-mounting detection apparatus of claim 13, wherein the at least one processor is configured to:
obtain, for each of the plurality of normal images, coordinates of three or more edges of the one or more markers, and
determine, as the normal position range, a region including the coordinates of the three or more edges of all of the plurality of normal images.

15. A non-transitory computer-readable recording medium storing a program, when executed by a processor, that causes a computer to execute the slide tray abnormal-mounting detection method of claim 1.
